(19) United States
(12) Patent Application Publication
(10) Pub. No.: US 2024/0155480 A1
(43) Pub. Date: May 9, 2024

(54) CELL SELECTION AT TRANSITION FROM IDLE MODE TO CONNECTED MODE

(71) Applicant: Nokia Solutions and Networks Oy, Espoo (FI)

(72) Inventors: Navin HATHIRAMANI, Dallas, TX (US); Karol SCHOBER, Espoo (FI)

(21) Appl. No.: 18/547,021

(22) PCT Filed: Feb. 7, 2022
(86) PCT No.: PCT/IB2022/051040

§ 371 Date: Aug. 18, 2023

(30) Foreign Application Priority Data
Feb. 22, 2021 (FI) 20215187

(51) Int. Cl. H04W 48/18; H04W 48/14; H04W 60/00

(52) U.S. Cl. CPC H04W 48/18; H04W 48/14; H04W 60/005; H04W 88/06

(57) ABSTRACT

An apparatus that is in idle mode and registered to a first radio access technology network and to a second radio access technology network may camp on a cell which is one of cells linked for spectrum sharing. The cells linked comprise at least a cell of a first type and a cell of a second type. When the apparatus is camping on such linked cell and detects a need to transit from the idle state to a connected state, the apparatus selects one of the linked cells, and performs initial access to a cell selected to transit from the idle mode to the connected state. The cell selected may be different than the cell camped on.

### TECHNICAL FIELD

Various example embodiments relate to wireless communications.

### BACKGROUND

Wireless communication systems are under constant development. To facilitate deployment of new radio access technologies, dynamic spectrum sharing, in which spectrum resources are dynamically shared between transmissions using a legacy radio access technology and transmissions using a new radio access technology can be implemented at least in some cells.

### BRIEF DESCRIPTION

The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to an aspect there is provided an apparatus comprising at least one processor; and at least one memory including computer program code, the at least one memory and computer program code being configured to, with the at least one processor, cause the apparatus at least to perform: register to a first radio access technology network and to a second radio access technology network; select, in response to detecting a need to transit from an idle state to a connected state in a camped on cell, which is one of cells linked for spectrum sharing, one of the cells linked, wherein the cells linked comprise at least a cell of a first type according to the first radio access technology and a cell of a second type according to the second radio access technology; and perform initial access to a cell selected to transit from the idle mode to the connected state.

In an embodiment, the at least one memory and computer program code are configured to, with the at least one processor, cause the apparatus further to at least to perform: determine movement speed of the apparatus; and use at least the movement speed when selecting the cell whereto perform the initial access.

In embodiments, the at least one memory and computer program code are configured to, with the at least one processor, cause the apparatus further to at least to perform: determine one or more signal characteristics of the cell of the first type comprised in the cells linked and signal characteristic of at least one neighbor cell of the second type; and use measured signal characteristics when selecting the cell whereto perform the initial access.

In embodiments, the at least one memory and computer program code are configured to, with the at least one processor, cause the apparatus further to at least to perform: detecting that the camped on cell is one of the linked cell based on information received at least from one of the first and second radio access technology networks.

In embodiments, the information is received in a dummy field in a system information block from the first radio access technology network.

In embodiments, the information is configuration information relating to the cells linked and being received in a prior connected mode.

In embodiments, the first radio access technology network is based on new radio access technology and the second radio access technology network is based on legacy radio access technology.

According to an aspect there is provided a method for an apparatus registered to a first radio access technology network and to a second radio access technology network, the method, when performed by the apparatus, comprising: detecting a need to transit from an idle state to a connected state in a camped on cell, which is one of cells linked for spectrum sharing, wherein the cells linked comprise at least a cell of a first type according to the first radio access technology and a cell of a second type according to the second radio access technology; selecting, in response to said detecting, one of the cells linked; and performing initial access to a cell selected to transit from the idle mode to the connected state.

In an embodiment, the method further comprises: determining movement speed of the apparatus; and using at least the movement speed when performing said selecting.

In embodiments, the method further comprises: determining one or more signal characteristics of the cell of the first type comprised in the cells linked and signal characteristic of at least one neighbor cell of the second type; and using measured signal characteristics when performing said selecting.

According to an aspect there is provided a computer-readable medium comprising program instructions, which, when run by an apparatus, causes the apparatus, when registered to a first radio access technology network and to a second radio access technology network, to carry out: selecting, in response to detecting a need to transit from an idle state to a connected state in a camped on cell, which is one of cells linked for spectrum sharing, wherein the cells linked comprise at least a cell of a first type according to the first radio access technology and a cell of a second type according to the second radio access technology, one of the cells linked; and performing initial access to a cell selected to transit from the idle mode to the connected state.

According to an aspect there is provided a non-transitory computer-readable medium comprising program instructions, which, when run by an apparatus, causes the apparatus, when registered to a first radio access technology network and to a second radio access technology network, to carry out: selecting, in response to detecting a need to transit from an idle state to a connected state in a camped on cell, which is one of cells linked for spectrum sharing, wherein the cells linked comprise at least a cell of a first type according to the first radio access technology and a cell of a second type according to the second radio access technology, one of the cells linked; and performing initial access to a cell selected to transit from the idle mode to the connected state.

According to an aspect there is provided a computer program comprising instructions which, when the program is executed by an apparatus, causes the apparatus, when registered to a first radio access technology network and to a second radio access technology network, to carry out: selecting, in response to detecting a need to transit from an idle state to a connected state in a camped on cell, which is one of cells linked for spectrum sharing, wherein the cells linked comprise at least a cell of a first type according to the first radio access technology and a cell of a second type according to the second radio access technology, one of the cells linked; and performing initial access to a cell selected to transit from the idle mode to the connected state.

According to an aspect there is provided an apparatus comprising means for: registering to a first radio access technology network and to a second radio access technology network; detecting a need to transit from an idle state to a connected state in a camped on cell, which is one of cells linked for spectrum sharing, wherein the cells linked comprise at least a cell of a first type according to the first radio access technology and a cell of a second type according to the second radio access technology; selecting, in response to said detecting, one of the cells linked; and performing initial access to a cell selected to transit from the idle mode to the connected state.

In an embodiment, the apparatus further comprises means for: determining movement speed of the apparatus and/or one or more signal characteristics of the cell of the first type comprised in the cells linked and signal characteristic of at least one neighbor cell of the second type; and using the movement speed and/or measured signal characteristics when performing said selecting.

### BRIEF DESCRIPTION OF DRAWINGS

Embodiments are described below, by way of example only, with reference to the accompanying drawings, in which

FIG. 1 illustrates an exemplified wireless communication system;

FIG. 2 illustrates an exemplified radio access system;

FIGS. 3 to 8 are flow charts illustrating different examples of functionalities; and

FIG. 9 is a schematic block diagram.

### DETAILED DESCRIPTION OF SOME EMBODIMENTS

The following embodiments are examples. Although the specification may refer to “an”, “one”, or “some” embodiment(s) in several locations, this does not necessarily mean that each such reference is to the same embodiment(s), or that the feature only applies to a single embodiment Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned. Further, although terms including ordinal numbers, such as “first”, “second”, etc., may be used for describing various elements, the structural elements are not restricted by the terms. The terms are used merely for the purpose of distinguishing an element from other elements. For example, a first element could be termed a second element, and similarly, a second element could be also termed a first element without departing from the scope of the present disclosure.

Embodiments and examples described herein may be implemented in any communications system comprising wireless connection(s). In the following, different exemplifying embodiments will be described using, as an example of an access architecture to which the embodiments may be applied, a radio access architecture based on new radio (NR, 5G) or long term evolution advanced (LTE Advanced, LTE-A), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), beyond 5G, wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

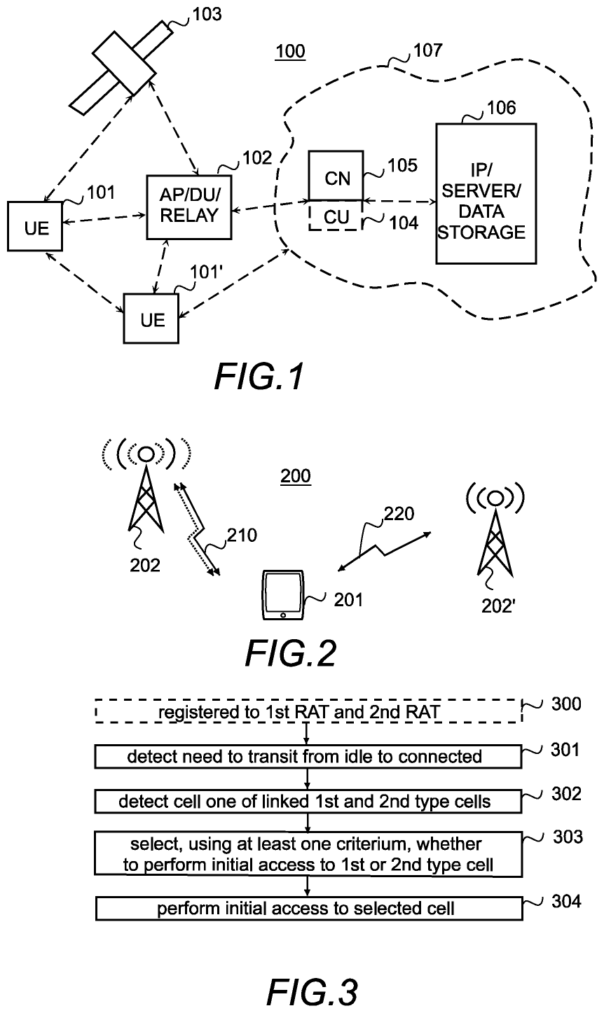

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 101 and 101′ configured to be in a wireless connection on one or more communication channels in a cell with an access node (such as (e/g)NodeB) 102 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point (AP) etc. entity suitable for such a usage.

A communications system 100 typically comprises more than one (e/g)NodeB in which case the (e/g)NodeBs may also be configured to communicate with one another over links, wired or wireless, designed for the purpose. These links may be used for signaling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 105 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), access and mobility management function (AMF), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus.

The user device typically refers to a portable computing device that includes wireless mobile communication devices operating with a subscription entity, for example a subscriber identification module (SIM), including, but not limited to, the following types of wireless devices: a mobile station (mobile phone), smartphone, personal digital assistant (PDA), handset, device using a wireless modem (alarm or measurement device, etc.), laptop and/or touch screen computer, tablet, game console, notebook, wearable device, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device may also utilise cloud. In some applications, a user device may comprise a small portable device with radio parts (such as a watch, earphones or eyeglasses) and the computation is carried out in the cloud. The user device is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes or corresponding network devices than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being integradable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 106, or utilise services provided by them. The communication network may also be able to support the usage of cloud services, for example at least part of core network operations may be carried out as a cloud service (this is depicted in FIG. 1 by “cloud” 107). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloud RAN architecture enables RAN real time functions being carried out at the RAN side (in a distributed unit, DU 102) and non-real time functions being carried out in a centralized manner (in a centralized unit, CU 104).

It should also be understood that the distribution of labour between core network operations and base station operations may differ from that of the LTE or even be non-existent Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite 103 in the mega-constellation may cover several satellite-enabled network entities that create on-ground cells. The on-ground cells may be created through an on-ground relay node 102 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as relay nodes, for example distributed unit (DU) parts of one or more integrated access and backhaul (IAB) nodes, or other network elements, etc. At least one of the (e/g)NodeBs or may be a Home (e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

Dynamic spectrum sharing (DSS) technology allows spectrum resources to be shared dynamically between 4G, or Long Term Evolution (LTE), and 5 G, or new radio, based on user demand. In cells linked for dynamic spectrum sharing, spectrum resources, for example physical resource blocks, may be dynamically allocated between 4G and 5G transmissions in the same band. Similar approach can be applied between different legacy radio access technologies, i.e. between 2G, 3G and 4G, and also to radio access technologies beyond 5G, for example between 5G and 6G, or 6G and 7G. (A new generation of radio access technology making its predecessor to a legacy radio access technology).

Also user devices (UEs, user apparatuses) may be configured to dynamically use two or more different radio access technologies, and to register to the two or more different radio access technologies, for example in response to power being switched on.

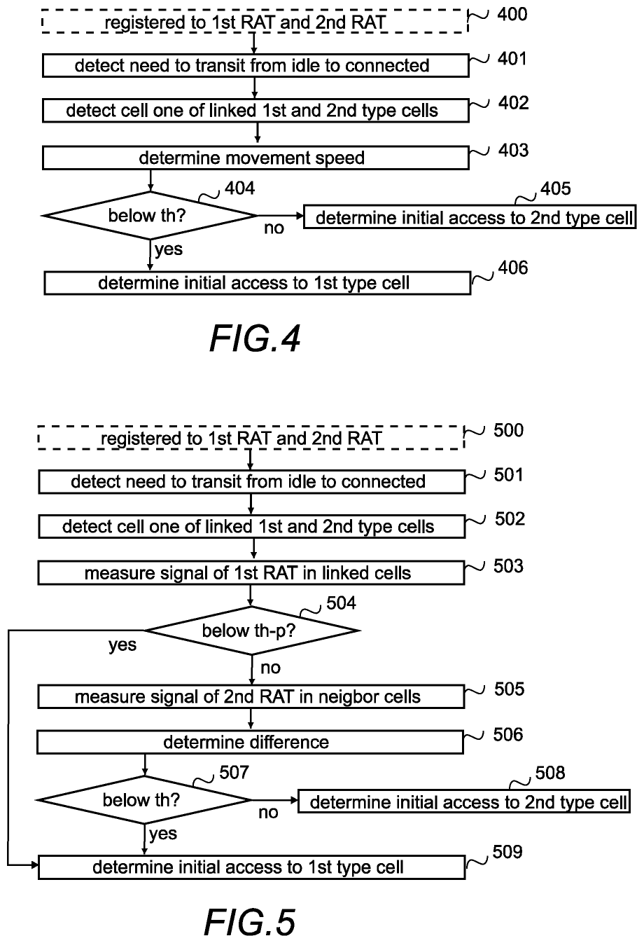

FIG. 2 illustrates a highly simplified example of a radio access system 200 in view of a user device 201 supporting the dynamic use of at least a first radio access technology and a second radio access technology, the user device being registered to radio access networks of a first type and a second type. The radio access network of the first type is based on the first radio access technology and the radio access network of the second type is based on the second radio access technology. A cell of the second type may have larger coverage area than a cell of the first type. Further, within a cell of the second type there may be two or more cells of the first type, and it may be that the dynamic spectrum sharing, or any corresponding band sharing including fixed spectrum sharing, is used between the cells of the first type and the cell of the second type. In other words, the cell of the second type may be linked with more than one cell of the first type.

Referring to FIG. 2, the user device 201 is camping on a cell provided by a base station 202. In the illustrated example, at least the base station 202 is configured to enable cells of different radio access technologies and to link the cells of different radio access technologies to provide the dynamic spectrum sharing between the cells of different radio access technologies. It should be appreciated that the term base station covers herein any apparatus configurable to provide an access node, including terminal devices and smart phones.

The user device 201 is in idle mode, in which it knows that the cell the user device is camping on is one of the cells linked for resource sharing. In the illustrated example, the cells linked are a cell of a first type and a cell of the second type. However, in the idle mode, the user device 201 is not aware whether neighbor cells (or a neighbor cell) provided by a base station 202′ are linked cells of the first type and of the second type, the user device knows the neighbor cell as a cell of the second type. In other words, even if the base station 202′ would link a neighbor cell of the first type and a neighbor cell of the second type, the neighbor cell of the second type appears to the user device 201 as if it were a cell of the second type without any linking. (The first type means the first radio access technology, depicted in FIG. 2 by dotted lines with the base station 202. The second type means the second radio access technology, depicted by solid lines with the base stations 202, 202′.)

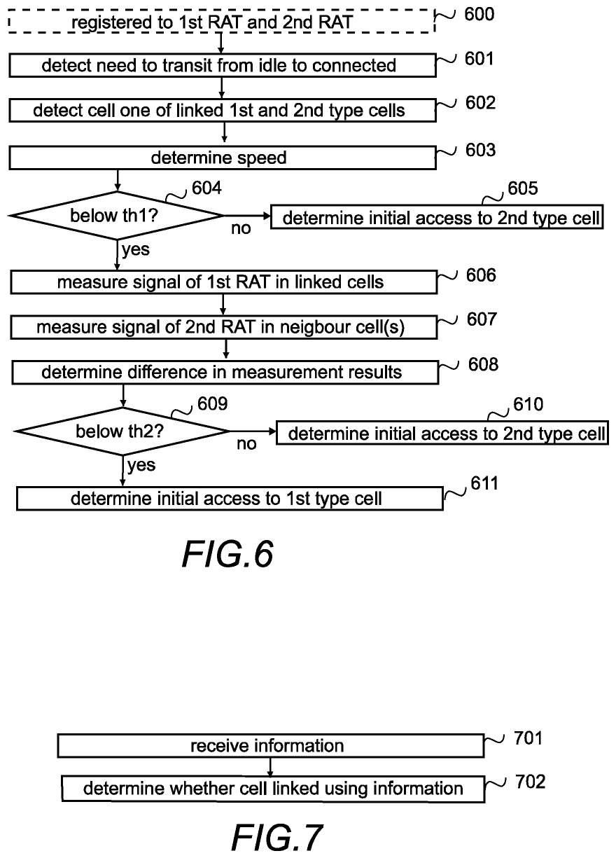

FIGS. 3 to 8 illustrates different example functionalities of a user device that has been registered to two different radio access technologies. The registration process per radio access technology is a normal registration process, and therefore there is no need to describe it in more detail herein. Hence the result of the registration process is shown in a block with a hashed line in FIGS. 3 to 8.

Referring to FIG. 3, the user device is (block 300) registered to a first radio access technology (1st RAT) network and to a second radio access technology (2nd RAT) network and is in idle mode. Then a need to transit from the idle mode to a connected mode is detected in block 301. The need may be detected because there is data to be transmitted from the user device, or data to be received by the user device. The user device detects (determines) in block 302 that the camped on cell is one of linked cells. In the example, the cells linked are a cell of a first type and a cell of a second type, wherein the first type is a type according to the first radio access technology and the second type is a type according to the second radio access technology. The user device may determine that the camped on cell is one of the linked cells of the first type and the second type, for example, based on stored information on prior connected mode operation in said cell, and/or based on received system information and/or based on one or more information elements in downlink control information. For example, one or more fields in a system information block and/or a parameter in a radio resource control message may be used for informing that cells are linked (i.e. (dynamic) spectrum sharing is supported).

Then the user device selects, in block 303, using at least one criterium, whether to perform initial access to the cell of the first type or to the cell of the second type. In other words, one of the cells linked is selected in block 303. The criterium may depend on the location of the user device in the cell, and/or on the type of the data and/or its transmission requirements (for example voice call, sending a video, downloading email) and/or whether the user device is moving. More detailed examples are given below. However, any criterium, or combined criteria, in which a deterministic rule is fulfilled, may be used. (A deterministic rule is a rule that results to the same end result when the same input is used.) The selection may be implemented using an AI based model.

Once the cell is selected, the user device performs in block 304 an initial access to the selected cell. The initial access may include cell reselection, if the selected cell is not the same as the cell the user device is camping on. After the initial access the user device proceed with connected mode procedures on the selected cell, the initial access including the transition from the idle mode to the connected mode. Since no modifications are needed to the transition and operations in connected mode, there is no need to describe in more detail the transition comprising a control connection establishment and a data connection establishment and the operations comprising data transmission. When returning back to idle mode, the user device may camp on the selected cell, or the user device may be configured to camp on a cell of the first type, if possible, or the user device may be configured to camp on a cell of the second type.

In the example illustrated in FIG. 4, it is assumed that if a user device is moving faster than a preset threshold, there may be a risk for a significant degradation caused by neighbor cell(s) of the second type if the user device is connected to the cell of the first type. The preset threshold may be hardcoded to the user device, or its value may be received in the system information and/or in one or more information elements in downlink control information, for example as part of the information indicating linking of cells for spectrum sharing. In a further example, the preset threshold may be set/updated by the user device re-using cell based mobility state determination, for example the number of performed cell reselections within a period of time.

Referring to FIG. 4, blocks 400 to 402 correspond to blocks 300 to 302 in FIG. 3, and therefore they are not repeated in vain herein. When it is detected (block 402) that the camped on cell is one of the cell of the first type and the cell of the second type linked for spectrum sharing, a movement speed of the user device is determined in block 403. Any known or future method to determine the movement speed may be used. For example, the cell based mobility state determination may be used, or the user device may comprise a velocity meter or a Global Positioning System (GPS) tracking unit wherefrom the movement speed may be acquired, or the user device may be connected to equipment, for example to a vehicle system, comprising one or more velocity meters wherefrom the movement speed may be acquired.

If the movement speed is not below the preset threshold (th) (block 404: no), the user devices determines in block 405 to perform the initial access to the cell of the second type. In other words, the user device selects the cell of the second type and then the process continues as described above with block 304 in FIG. 3.

If the movement speed is below the preset threshold (th) (block 404: yes), the user devices determines in block 406 to perform the initial access to the cell of the first type. In other words, the user device selects the cell of the first type and then the process continues as described above with block 304 FIG. 3.

It should be appreciated that in another example, if the movement speed is below the preset threshold (block 404: yes), the cell of the second type (block 405) is selected, resulting that if the movement speed is not below the preset threshold (block 404: no), the cell of the first type (block 406) is selected. In other words, depending on radio access technology capabilities and/or a physical layer design, different selection criteria and results may be determined.

In the example illustrated in FIG. 5, it is assumed that if a difference between one or more measured signal characteristics is bigger than a preset threshold (th), there is a risk for a significant degradation caused by non-linked neighbor cell(s) of the second type if the user device is connected to the cell of the first type. (Non-linked cell is a cell that is not linked with the camped on cell.) The threshold may be preset (hardcoded) to the user device, or its value may be received in the system information and/or in one or more information elements in downlink control information, for example as part of the information indicating the linking. Further, in the illustrated example of FIG. 5 an additional threshold (th-p) relating to signal characteristics is used. Also this additional threshold may be preset (hardcoded) to the user device, or its value may be received in the system information and/or in one or more information elements in downlink control information, for example as part of the information indicating the linking. In the illustrated example, the signal characteristics for which the additional threshold is set, is reference signal received power. However, any other signal characteristics or their combination could be used as well.

Referring to FIG. 5, blocks 500 to 502 correspond to blocks 300 to 302 in FIG. 3, and therefore they are not repeated in vain herein. When it is detected (block 502) that the camped on cell is one of the cell of the first type and the cell of the second type, linked for spectrum sharing, measuring signal characteristics of the camped on cell and of neighbor (neighboring) cells is performed. More precisely, in the linked cells, signal characteristics, or at least a reference signal received power, on the cell of the first type are measured in block 503. Then the measured reference signal received power is compared in block 504 with the additional threshold (th-p). If the measured reference signal received power is not below the additional threshold (block 504: no), signal characteristics on the cell of the second type are measured in block 505 in the neighbor cells, per neighbor cell. Depending on an implementation, the measured neighbor cells may, or may not, contain the linked cell of the second type. The measured signal characteristics may be a measured reference signal received power and/or a reference signal received quality and/or a signal-to-noise ratio. Then a difference between the biggest result in the non-linked neighbor cells and the result in the linked cell of the first type is determined in block 506.

If the difference is not below the threshold (th) (block 507: no), the user devices determines in block 508 to perform the initial access to the cell of the second type. In other words, the user device selects the cell of the second type and then the process continues as described above with block 304 in FIG. 3.

If the difference is below the preset threshold (th) (block 507: yes), the user devices determines in block 509 to perform the initial access to the cell of the first type. In other words, the user device selects the cell of the first type and then the process continues as described above with block 304 in FIG. 3.

If the measured reference signal received power is below the additional threshold (block 504: yes), the process proceeds to block 509 to perform the initial access to the cell of the first type. In other words, below a certain value of the measured reference signal received power, the first radio access network is preferred.

In another implementation the check in block 504 is omitted and the process proceeds directly from block 503 to block 505.

FIG. 6 illustrates an example in which the assumptions of FIGS. 4 and 5 relating to significant degradation are combined. However, in the example no additional thresholds are used.

Referring to FIG. 6, blocks 600 to 605 correspond to blocks 400 to 405 in FIG. 4, and therefore they are not repeated in vain herein. When the movement speed has been determined (block 603) and it is not below the preset threshold (th1) for the movement speed (block 604: no), the user devices determines in block 605 to perform the initial access to the cell of the second type. In other words, the user device selects the cell of the second type and then the process continues as described above with block 304 in FIG. 3.

If the movement speed is below the preset threshold (th1) for the movement speed (block 604: yes), measuring signal characteristics of the camped on cell and of neighbor (neighboring) cells is performed. More precisely, signal characteristics on the linked cell of the first type are measured in block 606, and signal characteristics on the cell of the second type are measured in block 607 in the neighbor cells, per a neighbor cell, as described with blocks 503 and 505 with FIG. 5. Then a difference between the biggest result in the non-linked neighbor cells and the result in the linked cell of the first type is determined in block 608.

If the difference is not below the threshold (th2) for signal characteristics (block 609: no), the user devices determines in block 610 to perform the initial access to the cell of the second type in the linked cells. In other words, the user device selects the cell of the second type and then the process continues as described above with block 304 in FIG. 3.

If the difference is below the threshold (th2) for signal characteristics (block 609: yes), the user devices determines in block 611 to perform the initial access to the cell of the first type. In other words, the user device selects the cell of the first type and then the process continues as described above with block 304 in FIG. 3.

FIG. 7 illustrates basic principles how the user device detects/determines that the camped on cell is one of linked cells.

Referring to FIG. 7, the user device receives in block 701 information from at least one of the radio access networks. The information is used when the user device determines (detects) in block 702, whether the camped on cell is one of linked cells.

If the information is received in block 701 in a connected mode, the user device may store the information before transiting to the idle mode so that the information is available when a transition from the idle mode to the connected mode is initiated.

The information may be received in block 701 in the idle mode, for example in control information sent in the camped on cell.

Assuming that the radio access technologies are 5G and LTE, the information may be received, for example:
In a dummy field in a system information block from the 5G network (dummy field meaning a field not currently in use), for example a dummy field in system information block 5.
In an information element indicating, whether 5G employs Cell Reference Symbols (CRS) Rate Matching (RM) (when employed, cells are linked)
In a system information block indicating uplink raster shift is configured for 5G cell, indicating the existence of a linked cell of a second type
In a system information block indicating Multimedia Broadcast multicast service Single Frequency Network (MBSFN) configuration
In connected mode configuration of physical downlink shared channel in 5G

It should be appreciated that the above list is a non-limiting list, and other ways to convey the information may be used as well.

In the example illustrated in FIG. 8 the principles described above are applied in a solution in which the radio access technologies are 5G and LTE (4G). Further, in the example term “dynamic spectrum sharing cell” is used as a synonym to expressions “one of cells linked” and “one of linked cells”.

Referring to FIG. 8, the user device is (block 800) registered to a 5G network and to an LTE network and is in idle mode. The user device monitors (block 801), whether the user device needs to initiate a data transmission. If not (block 801: no), the user device is (block 802) in an idle mode camping on a cell which, when possible, is selected based on radio access technology prioritization provided for camping, for example, by the network. The radio access technology prioritization may be provided by the LTE network, or by the 5G network, or by both networks.

When it is detected that the user device needs to initiate a data transmission (block 801: yes), the user device determines (block 803), whether it is camping on a dynamic spectrum sharing (DSS) cell. In other words, it is checked, whether a 5G cell and an LTE cell are linked. As said above, this may be determined based on information on prior connected mode operation in the 5G cell, for example.

If the user device is not camping on a dynamic spectrum sharing cell (block 803: no), the user device initiates in block 804 data session to the cell it is camping on. In other words, there is no dynamic spectrum sharing cell, hence no cell selection prior to transition to connected mode needs to be made.

If the user device is camping on a dynamic spectrum sharing (DSS) cell (block 803: yes), it is checked in block 805 whether the user device is in a normal mobility state according to 5G definitions for the normal state. According to 5G definitions, the mobility state can be determined based on speed dependent reselection parameters that are broadcast in system information.

If the user device is in the normal mobility state (block 805: yes), the user device measures in block 806 a 5G signal in the linked 5G cell (which usually is the 5G cell the user device is camping on, since usually 5G is prioritized for camping) and in block 807 LTE signals in neighbor cells. For example, reference signal reception power and/or reference signal reception quality per a received reference signal per a cell is measured in blocks 806 and 807.

Then the measurement results are used in block 808 to select, using preset criteria, a 5G cell or an LTE cell (one of linked cells). Examples of the preset criteria are given above with FIG. 5.

Once the selection has been performed, it is checked in block 809, whether the user device is camping on the selected cell.

If the user device is not camping on the selected cell (block 809: no), a reselection to the selected cell is performed in block 810, and then a data session to the selected cell is initiated in block 811. For example, if the user device is camping on a 5G cell, and the selected cell is an LTE cell, reselection to the LTE cell is performed in block 810.

If the use device is camping on the selected cell (block 809: yes), the data session to the selected cell is initiated in block 811.

If the mobility is not the normal mobility (block 805: no), in the illustrated example the user device selects in block 812 an LTE cell, and then proceeds to step 809 to check, whether the selected cell (the LTE cell) is the one the user device is camping on.

It should be appreciated that in the example of FIG. 8, initiating the data session includes initiating a transition from the idle mode to the connected mode and performing initial access to the selected cell.

As can be seen from the above examples, selecting in a cell linking two or more cells of different type (different radio access technology type), one of the cells to be used in a transition from the idle mode to the connected mode, a risk that the initial access is performed to a cell with a risk of high degradation caused by neighbor cell(s), is avoided. Further, there is no need to implement in user devices a specific interference cancellation. For example, there is no need to perform cell specific reference symbol cancellation for LTE in 5G modems of user devices.

In addition, in the examples illustrated by FIGS. 5, 6 and 8, it is possible to maximize spectral efficiency for DSS cells based on location of the user device within the DSS cell and level of interference from neighbor LTE cells, the location and the level of interference being determinable using reference signal reception power (providing signal strength) and/or reference signal reception quality (relating to a load of the cell) and/or signal-to-noise ratio/signal-to-interference-plus-noise ratio.

The blocks, related functions, and information exchanges described above by means of FIGS. 2 to 8 are in no absolute chronological order, and some of them may be performed simultaneously or in an order differing from the given one. Other functions can also be executed between them or within them, and other information may be transmitted, and/or other rules applied. Some of the blocks or part of the blocks or one or more pieces of information can also be left out or replaced by a corresponding block or part of the block or one or more pieces of information. For example, one of the radio access networks may provide additional information, for access via system information messages, to control, or assist the user device in selection between the cell of the first type and the cell of the second type.

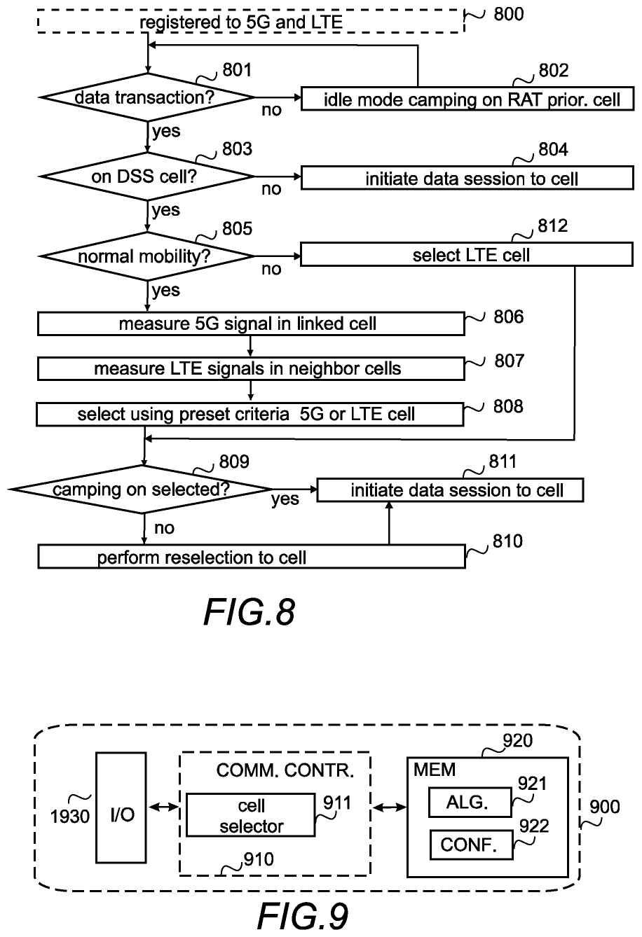

FIG. 9 illustrates an apparatus comprising a communication controller 910 such as at least one processor or processing circuitry, and at least one memory 920 including a computer program code (software, algorithm) ALG. 921, wherein the at least one memory and the computer program code (software, algorithm) are configured, with the at least one processor, to cause the apparatus to carry out any one of the embodiments, examples and implementations described above using the term user device. The apparatus of FIG. 9 may be an electronic device, for example a wearable device, a home appliance device, a smart device, like smart phone or smart screen, a vehicular device, just to name couple of examples.

Referring to FIG. 9, the memory 920 may be implemented using any suitable data storage technology, such as semiconductor based memory devices, flash memory, magnetic memory devices and systems, optical memory devices and systems, fixed memory and removable memory. The memory may comprise a configuration storage CONF. 921, such as a configuration database, for storing configurations, for example spectrum sharing configurations and prior connected mode configuration(s). The memory 920 may further store measurement reports, and/or one or more thresholds used in selection, and/or a data buffer for data waiting for transmission and/or data waiting to be decoded.

Referring to FIG. 9, the apparatus 900 may further comprise one or more communication interfaces 930 comprising hardware and/or software for realizing communication connectivity according to two or more radio communication protocols via two or more different radio access technologies. The one or more communication interfaces 930 may provide the apparatus with radio communication capabilities according to two or more different radio access technologies with one or more base stations (access nodes) of a wireless network. A communication interface may comprise standard well-known analog radio components such as an amplifier, filter, frequency-converter and circuitries, conversion circuitries transforming signals between analog and digital domains, and one or more antennas. Digital signal processing regarding transmission and/or reception of signals may be performed in a communication controller 910.

The apparatus 900 may further comprise an application processor (not illustrated in FIG. 9) executing one or more computer program applications that generate a need to transmit and/or receive data. The application processor may execute computer programs forming the primary function of the apparatus. For example, if the apparatus is a sensor device, the application processor may execute one or more signal processing applications processing measurement data acquired from one or more sensor heads. If the apparatus is a computer system of a vehicle, the application processor may execute a media application and/or an autonomous driving and navigation application. In an embodiment, at least some of the functionalities of the apparatus of FIG. 9 may be shared between two physically separate devices, forming one operational entity. Therefore, the apparatus may be seen to depict the operational entity comprising one or more physically separate devices for executing at least some of the processes described above.

The communication controller 910 may comprise a controlling entity unit (cell selector) 911 configured to perform cell selection related functionality according to any one of the embodiments/examples/implementations described above.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a cellular network device.

In an embodiment, at least some of the processes described in connection with FIGS. 2 to 8 may be carried out by an apparatus comprising corresponding means for carrying out at least some of the described processes. The apparatus may comprise separate means for separate phases of a process, or means may perform several phases or the whole process. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry. In an embodiment, the at least one processor, the memory, and the computer program code form processing means or comprises one or more computer program code portions for carrying out one or more operations according to any one of the embodiments/examples/implementations described herein.

According to yet another embodiment, the apparatus carrying out the embodiments comprises a circuitry including at least one processor and at least one memory including computer program code. When activated, the circuitry causes the apparatus to perform (carry out) at least some of the functionalities according to any one of the embodiments/examples/implementations of FIG. 2 to 8, or operations thereof.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art Additionally, the components of the systems (apparatuses) described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments/examples/implementations as described may also be carried out in the form of a computer process defined by a computer program or portions thereof. Embodiments of the methods described in connection with FIGS. 2 to 8 may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium, for example. Coding of software for carrying out the embodiments as shown and described is well within the scope of a person of ordinary skill in the art. In an embodiment, a computer-readable medium comprises said computer program.

Even though the invention has been described above with reference to examples according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1-15. (canceled)

16. An apparatus comprising
at least one processor; and
at least one memory including computer program code, the at least one memory and computer program code configured to, with the at least one processor, cause the apparatus at least to perform:
register to a first radio access technology network and to a second radio access technology network;
select, in response to detecting a need to transit from an idle state to a connected state in a camped on cell, which is one of cells linked for spectrum sharing, one of the cells linked, wherein the cells linked comprise at least a cell of a first type according to the first radio access technology and a cell of a second type according to the second radio access technology; and
perform initial access to a cell selected to transit from the idle mode to the connected state.

17. The apparatus according to claim 16, wherein the at least one memory and computer program code configured to, with the at least one processor, cause the apparatus further to at least to perform:
determine movement speed of the apparatus; and
use at least the movement speed when selecting the cell whereto perform the initial access.

18. The apparatus according to claim 16, wherein the at least one memory and computer program code configured to, with the at least one processor, cause the apparatus further to at least to perform:
determine one or more signal characteristics of the cell of the first type comprised in the cells linked and signal characteristic of at least one neighbor cell of the second type; and
use measured signal characteristics when selecting the cell whereto perform the initial access.

19. The apparatus according to claim 16, wherein the at least one memory and computer program code configured to, with the at least one processor, cause the apparatus further to at least to perform:
detecting that the camped on cell is one of the linked cell based on information received at least from one of the first and second radio access technology networks.

20. The apparatus according to claim 19, wherein the information is received in a dummy field in a system information block from the first radio access technology network.

21. The apparatus according to claim 19, wherein the information is configuration information relating to the cells linked and being received in a prior connected mode.

22. The apparatus according to claim 16, wherein the first radio access technology network is based on new radio access technology and the second radio access technology network is based on legacy radio access technology.

23. A method for an apparatus registered to a first radio access technology network and to a second radio access technology network, the method, when performed by the apparatus, comprising:
detecting a need to transit from an idle state to a connected state in a camped on cell, which is one of cells linked for spectrum sharing, wherein the cells linked comprise at least a cell of a first type according to the first radio access technology and a cell of a second type according to the second radio access technology;
selecting, in response to said detecting, one of the cells linked; and
performing initial access to a cell selected to transit from the idle mode to the connected state.

24. The method according to claim 23, further comprising:
determining movement speed of the apparatus; and
using at least the movement speed when performing said selecting.

25. The method according to claim 23, further comprising:
determining one or more signal characteristics of the cell of the first type comprised in the cells linked and signal characteristic of at least one neighbor cell of the second type; and
using measured signal characteristics when performing said selecting.

26. A computer-readable medium comprising program instructions, which, when run by an apparatus, causes the apparatus, when registered to a first radio access technology network and to a second radio access technology network, to carry out:
selecting, in response to detecting a need to transit from an idle state to a connected state in a camped on cell, which is one of cells linked for spectrum sharing, wherein the cells linked comprise at least a cell of a first type according to the first radio access technology and a cell of a second type according to the second radio access technology, one of the cells linked; and
performing initial access to a cell selected to transit from the idle mode to the connected state.

27. The computer-readable medium according to claim 26, wherein the computer-readable medium is a non-transitory computer-readable medium.
